(19) United States
(12) Patent Application Publication
(10) Pub. No.: US 2018/0029312 A1
(43) Pub. Date: Feb. 1, 2018

(54) METHOD FOR THE PRODUCTION OF PLASTIC PARTS

(71) Applicant: ENGEL AUSTRIA GmbH, Schwertberg (AT)

(72) Inventors: Lorenz REITH, Linz (AT); Manuel WEISSINGER, Bad Kreuzen (AT); Norbert MUELLER, Passau (DE); Gerhard SPERNEDER, Klam bei Grein (AT); Gerald SCHOEFER, Pabneukirchen (AT)

(21) Appl. No.: 15/663,143

(22) Filed: Jul. 28, 2017

(30) Foreign Application Priority Data
Jul. 29, 2016 (AT) A 50695/2016

(51) Int. Cl. B29C 67/24

(52) U.S. Cl. CPC B29C 67/246; B29C 45/22

(57) ABSTRACT

A method for the production of plastic parts, in particular of composite parts, utilizes at least two components to be mixed in a mixing chamber and a cavity formed between a first and a second mold half of a molding tool. The cavity comprises a mold part section and a sprue section, and the sprue section or the mold part section is used as mixing chamber.

The invention concerns a method for the production of plastic parts with the features of the preamble of claim 1, a molding tool for the use in such a method and a molding machine with such a molding tool.

The cavity formed in the molding tool comprises a sprue section and a mold part section, wherein the mold part section at least at the end of the production process substantially corresponds to the form of the finished plastic part and wherein the sprue part is located in the sprue section at the end of the production process.

In the field of the reactive processing the trend is increasing in the direction of the processing or the production of material-wise recyclable matrix systems. In this context the anionic polymerization of caprolactam has to be particularly mentioned as an efficient lightweight construction technology.

For the production of polycaprolactam (PA 6) by anionic polymerization, mostly two-component systems are used which are mixed with each other in the ratio of 1:1. Component 1, in the following referred to as activating component, consists of caprolactam and one or several substances from the group of the polymerization activating agents, for example hexamethylen-dicarbamoyl-caprolactam. Additionally, fillers or other additives, for example for an improvement of the flame protection, for the coloring, etc., can be added. Component 2, in the following referred to as catalyzing component, consists of caprolactam and a polymerization catalyzing agent or initiating agent. Here it is common to use metallic salts of caprolactam.

The high-pressure resin injection process is increasingly used for the series production of fiber composite parts and is characterized by the following process steps:

A semi-finished fiber product (also called preform) is inserted into the cavity of the molding tool and molding tool is closed. After removing the residual air from the cavity by applying a low pressure, the injection process starts. In doing so, the reactive components (e. g. polyol and isocyanate in the case of polyurethane production) are supplied to the mixing head and are mixed in the mixing head and are brought into the cavity. Thereby, the inserted semi-finished fiber product is impregnated. Thereafter, the reactive system is fully cured. After the opening of the molding tool has been carried out, the finished fiber composite part can be taken out.

In the case of the processing of two-component or multi component reactive systems in the high-pressure resin injection process, the use of high-pressure countercurrent mixing heads has prevailed in the series production. Exemplary embodiment are indicated among other in the DE 10 2007 023 239 A1.

Basically, when operating such mixing heads there is a differentiation between distinct operating modes: In the recirculation mode the respective reactive components are conducted in a circuit by the mixing head but are not mixed with each other. Instead, the reactive components are respectively recirculated to the metering machine by means of a groove on the discharge slider of the mixing head.

By a reverse movement of the discharge slider, the injection mode can be started. In doing so, the reactive components are atomized under high pressure and are mixed in the countercurrent of the mixing chamber which is now exposed. In this way, a homogeneous intermixing can be guaranteed also in the case of components with different properties (viscosity, surface tension, potentially admixed fillers). For finishing the injection, the material still located in the mixing chamber is pressed in the direction of the cavity by a movement of the discharge slider (cleaning rod, . . . ) so that the mixing chamber is entirely cleaned with each injection cycle. The reactive components are now again recirculated.

The dimensioning and the construction of the used discharge slider are primarily dependent on the material to be processed and on its amount. For example, this slider can be designed metallic or ceramic; often this slider is additionally hardened. In particular for the processing of ε-caprolactam, in the DE 32 38 258 C2, however, an adapted geometry is suggested.

In the high-pressure technology, in particular in the case of the admixing of polyurethanes, it has prevailed to mix the components against the outlet direction of the mixing head in order to maximize the flow path of the components in the mixing chamber.

Alternatively, for the admixing of reactive components for the production of massive or foamed plastic parts, mixing chambers which are integrated in the molding tool have already been suggested:

The DE 1 948 999 discloses such a mold-integrated mixing chamber which is arranged in the molding tool parting plane. After the curing process of the reactive components has been carried out, these reactive components are demolded together with the molded part. The supplying of the two reactive components, thus, is realized in such a way that one component is conducted via the upper side of the mixing chamber and the other component is conducted via the lower side. Thus, a feeding is located each on the molding tool upper side and lower side.

A comparably arrangement is disclosed in the DE 2 422 976. Also in this case the mixing chamber is located in the parting plane and can be demolded together with the finished mold part. However, this mixing chamber is connected with the cavity only by a bore (injection hole opening).

Further, the EP 1 847 367 A1 discloses a related mixing chamber which is described as an element of the molding tool or also of the corresponding closing unit. This mixing chamber, however, can also be operated in recirculation comparable with the high-pressure resin injection processes already mentioned above.

Alternatively, in the case of low-pressure mixing heads the mixing chamber can be flushed after each shot with a cleaning substance (e. g. solvents or one of the reactive components). This is accompanied with additional amounts of waste and loss of time, which is why these processes are not deployed in the case of high performance systems.

For the processing of polyurethanes or epoxy resins, the use of high pressure countercurrent mixing heads has proven largely. For the use and the admixing of low-viscosity reactive media, however, there are still major challenges:

As largest weakness, certainly the sealing of the discharge slider has to be mentioned. Here it has to be worked with extremely accurate tolerances in the μm range. This increases in a large extent the corresponding production and maintenance costs. Moreover, these systems are very error-prone. In particular the augmented trend for the production of fiber-reinforced parts with a fiber volume fraction of up to 55% further leads to the case that significant pressures for the filling of the form are needed and, thus, the corresponding sealing has to be guaranteed also with up to 200 bar.

Already slight leakages in the area of the discharge slider can lead thereto that residual material remains in the mixing chamber and is curing there. Thus, the mixing chamber can no longer be entirely cleaned. This can lead to malfunctions during the next injection cycle.

In the case of high pressure countercurrent mixing heads according to the state of the art, the discharge device and its drive are arranged linearly one after the other, which reflects correspondingly negative in the constructional height. The latter is commonly disadvantageous in the case of closing units with high pressure forces and is especially disadvantageous in the case of closing units for injection molding machines. Further, appropriate spacious recesses have to be considered in each molding tool.

Further, during the admixing of the components in common mixing heads designed to produce PUR, there is a dispersion of gases which can later lead to a foaming or degassing and, thus, the surface quality of the obtained part is impaired.

Also the approaches for the use of mold-integrated mixing chambers disclosed up to now do not solve the problem of the admixing and the processing of low-viscosity lactam melt in a satisfactory way.

Primarily, the arrangement of the injection nozzles to each other has to be mentioned here. As also known with the high pressure countercurrent mixing heads, the directly opposite positioning of the component supplying or of the injection nozzles to each other facilitate a crosswise foaming of the components. This implicates a significant process risk.

The use of a tapered mixing chamber and a transfer of the reactive mixture into the molding cavity by means of an injection hole opening can moreover be seen particularly disadvantageous as by the tapering a—to the necessary admixing and injection pressure—additional pressure has to be applied by the injection unit.

Additionally, the arrangements disclosed until now cannot easily be used, in particular with the production of fiber-reinforced plastic parts: For example, a lateral flow onto the inserted fiber part/preform leads to the case that this fiber part/preform is displaced in the molding tool and fiber clusters are formed which can no longer be impregnated by the reactive mixture. Further, resin clusters in the sprue section can lead to a premature hardening of the material because of the mostly high exothermal crosslinking reaction. Therefore, in particular the injection hole openings already described above can easily get clogged.

Further, those arrangements have additionally constructional disadvantages whose component supply is arranged in different halves of the molding tool: Thus, corresponding measures for the temperature insulation have to be taken in both halves, the space requirement for the supply of the components is significantly increased and also provisions for the nozzle control, the tempering and the media guidance have to be realized in both halves.

In the case of the two-component processing of ε-caprolactam components for the anionic polymerization it was shown that the necessary pressures for a homogeneous mixing of the components are quite small because of the low processing viscosity. Different from for example with polyurethane or epoxy resin systems, the material further does not show any demixing tendencies once mixing has occurred.

Nevertheless, for high quality parts it is often necessary to realize high internal mold pressures of up to 200 bar. Even when reaching a correspondingly high internal mold pressure, the above mentioned mixing pressure in the sprue section has still to be ensured.

Summarizing it can be said that there is still significant potential for improvement concerning the technical requirements for the mixing and supplying of liquid reactive systems.

The object of the invention is the provision of a generic method, a molding tool for the use in such a method and a molding machine with such a molding tool, wherein the above discussed problems are prevented.

This object is achieved by a method with the features of claim 1, a molding tool for the use in such a method and a molding machine with such a molding tool. Advantageous embodiments of the invention are defined in the dependent claims.

In a first variant of the invention the sprue section of the cavity serves as the mixing chamber. In a second variant of the invention the mold part section of the cavity serves as the mixing chamber.

The invention is particularly suitable for the production of plastic parts in the form of composite parts, in particular made of lactam-based two-component reactive systems.

Preferably, the method according to the invention is provided for reactive materials with an activating component and a catalyzing component and for the production of fiber-reinforces plastic parts. The following disclosure exemplarily relates to such a method.

Thus, it is suggested to mix the activating component and the catalyzing component directly in the sprue section or in the mold part section of the cavity of a molding tool.

In the first variant of the invention, the at least two components are preferably supplied into the sprue section or into the mold part section by actively operable injection nozzles or similar closing elements. Especially for high reactive systems with short curing times, thus, also the flow paths after the mixing are significantly reduced.

In both variants of the invention needle shut-off nozzles are preferably used, wherein particularly preferred in the closed position the nozzle needles directly seal the component supply on the sprue section and in the open position a discharge opening of between 0.2 mm and 2 mm for the material flow into the sprue section is provided. A particularly effective mixing of the components is reached when the discharge of the components from each discharge opening is not provided as a jet but as a spraying cone.

Particularly preferred when using needle shut-off nozzles, measures should be taken in order to reach a sufficiently precise adjustment of the travel of the shut-off needle, especially as in the case of a given flow speed also the mixing pressure can be adjusted very exact by the length of the travel.

Besides the size of the material-supplying bores into the sprue section as well as their distance, the angle with which the components meet each other during the injection is disposed as an optimizing parameter for the optimization in terms of flow mechanics of the whole sprue section. This angle most widely corresponds to the angle of the nozzles to each other.

Preferred is an embodiment where the sprue section is situated normal to the parting plane. Especially with the production of fiber composite parts, this arrangement has the significant advantage that there is no displacement of fibers or rovings during the impregnation of the fabric.

The whole sprue section is provided in one half of the molding tool and is completely filled with the reactive mixture during the process and is cured to the plastic part. In this manner the sprue part curing in the sprue section can be demolded together with the plastic part during the process.

Preferably, the sprue section can also be designed as an insert in order to reach a variation—which is for example adapted for the semi-finished fiber product—of the flow speed or the mixing pressure.

In particular in can be helpful for the demolding to arrange an ejector directly in the sprue section.

Preferably, also a vacuum module can be arranged directly in the sprue section

Alternatively, it can be advantageous for the control of the process to use a pressure sensor which is arranged directly in the sprue section.

The polymerization formulations used for the production of the fiber-reinforced plastic parts can be adjusted concerning their additivation in such a way that depending on the temperature curing times between 60 seconds and 300 seconds can be reached. Here, the thermal capacity of the used textile inlay (glass fiber or carbon fiber) has a significant influence on the reaction profile so that the optimum curing time for the pure resin areas and for the fiber-reinforced areas is different. Because of the resin accumulation in the sprue section, thus, a separate tempering for the sprue section can be provided.

Also the media supply in or on the molding tool can be tempered separately in order to hold the thermal stress of the material low. Here, in particular a temperature range between 90° C. and 140° C. has proved itself.

As the access to the sprue section can be rather difficult depending on the arrangement in the molding tool, it is further suggested as an option to provide a closable cleaning or flushing conduit or a switchable drain bore in the sprue section.

A method according to the invention for the production of fiber-reinforced polyamide parts can be carried out in a first variant (mixing in the sprue section) as follows:

Initially, a fiber insert is placed in a mold part section of a cavity of a molding tool. The molding tool is closed and optionally evacuated. Thereafter, the activating component and the catalyzing component are supplied to the injection nozzles by means of tempered conducts. The components are provided in melted form by a metering unit with the desired pressure and volume flow. The shut-off nozzles can be opened with the start of the supplying of the components (this can be carried out shortly before, during or also shortly after the start of the supplying of the melt components). With the discharge into the sprue section the mixing of the reactive components is carried out and the mixture is driven out into the mold part section of the molding tool. Here the fiber insert is impregnated. With the increasing filling level and the pressure build-up also the sprue section is filled with the reactive mixture. With the completion of the injection the shut-off nozzles are closed. The reactive mixture is cured under temperature. After the curing has been carried out, the molding tool is opened and the plastic part together with the sprue part is demolded. Optionally, the sprue part can already by removed in the molding tool and the plastic part can be demolded subsequently.

In a second variant of the invention the injecting and mixing of the components is carried out directly in the mold part section.

Here, for mixing the components, the nozzles of the mixing system are preferably introduced separate from each other in the two halves of the molding tool; one nozzle is introduced in the first half and one nozzle is introduced in the second half.

The nozzles can be oriented directly onto each other or can be arranged in an inclined angle to each other. The nozzles can also be arranged in a defined axial offset to each other. The mixing behavior in the mixing section can be significantly influenced by means of the arrangement of the nozzles.

The mixing of the components takes place directly in the surface of the produced part. There, a one-sided or two-sided mixing calotte can be formed in the mixing section. The mixing section can also be formed as a pair of a concave and a convex molding tool wall. Finally, the mixing section can be formed plain on the outer side as well as on the inner side; this means no additional geometric adaptations are made in the mixing section.

The mixing behavior can also be influenced by the geometric design of the molding tool wall in the mixing section. Thereby, the resulting mixing behavior is defined by the nozzle geometry, the nozzle control, the arrangement of the nozzles to each other and by the design of the molding tool wall in the section of the nozzles. For this purpose, exchangeable inserts in the molding tool can be provided.

The mixing section can be covered with a preform passing through unchanged; this means in a preferred embodiment no particular design of the preform is provided in the mixing section. Alternatively, the preform can be fully or partly thinned out or can be hollow in the mixing section. With this local adaptation of the preform the mixing behavior in the mixing section can be influenced.

The advantage of the second variant of the invention is that one the one hand no discharge slider or cleaning rod is necessary which suppresses the material still present in the mixing chamber at the of the injection. If in the case of a conventional nozzle arrangement in one molt half no discharge slider or cleaning rod is provided, then a sprue peg or a sprue rib or similar remains. With the herein disclosed solution, where the injection and the mixing is carried out directly in the mold part section, no sprue geometry remains which—as appropriate—would have to be separated and causes amounts of waste.

Embodiments of the invention are discussed based on the drawings, wherein:

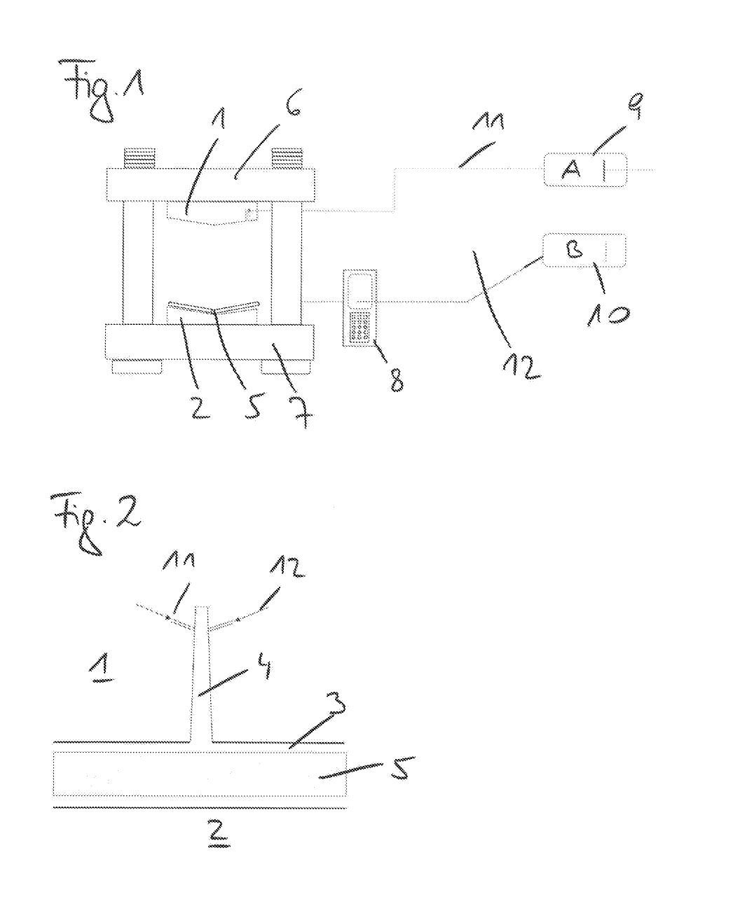

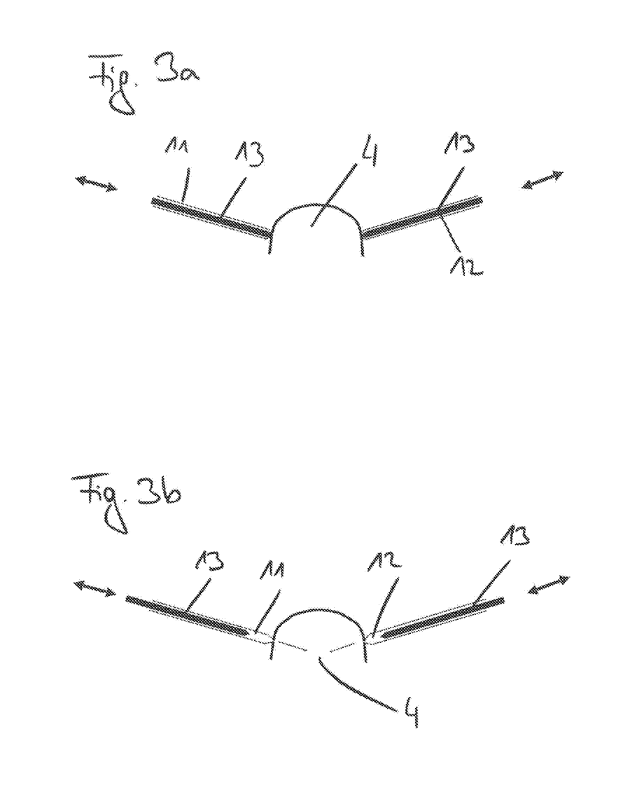

FIG. 1 shows a schematic view of a molding machine according to the invention,

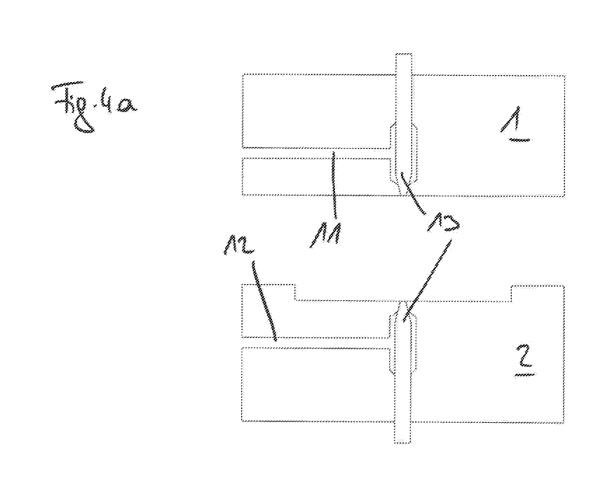

FIG. 2 shows a detail of the molding tool of the molding machine of FIG. 1 in a first variant of the invention,

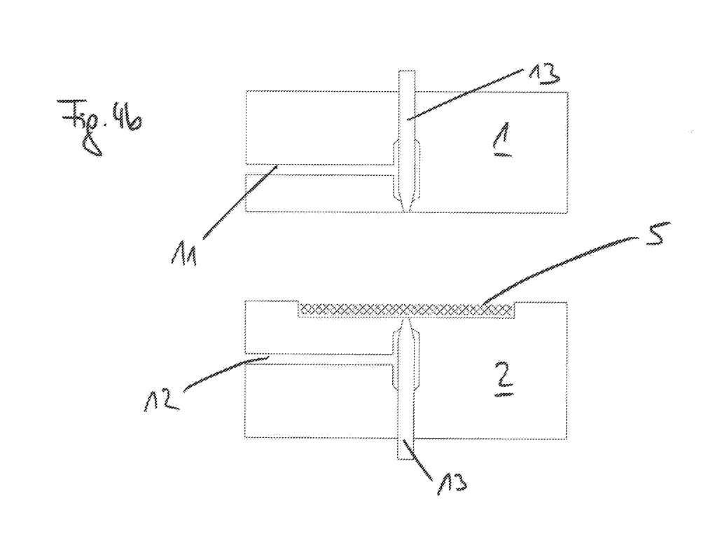

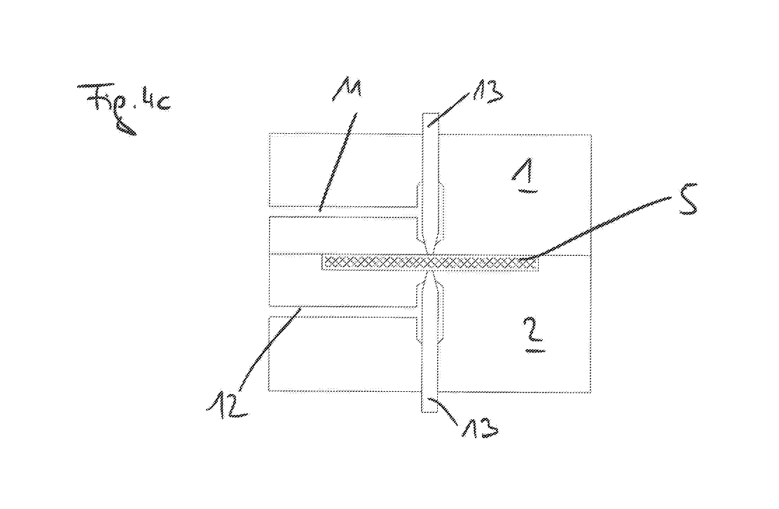

FIGS. 3a, 3b show a detail of a molding tool of the molding machine of FIG. 1 in a first variant of the invention for two different points in time during the production process,

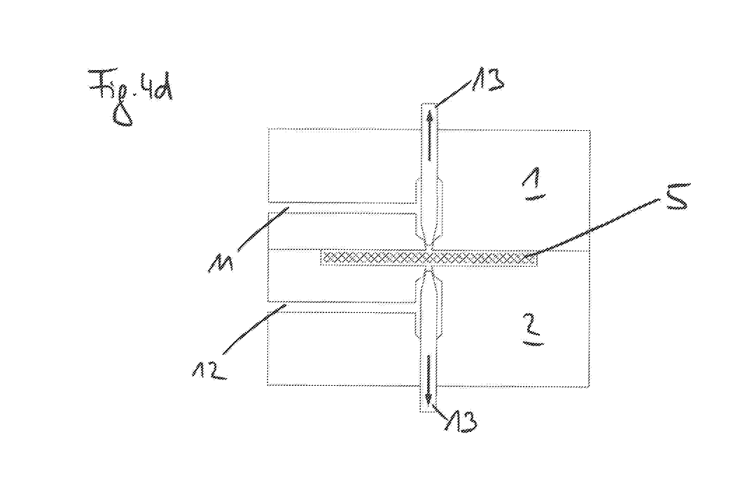

FIGS. 4a-4e show a detail of a molding tool of the molding machine of FIG. 1 in a second variant of the invention for several different points in time during the production process and

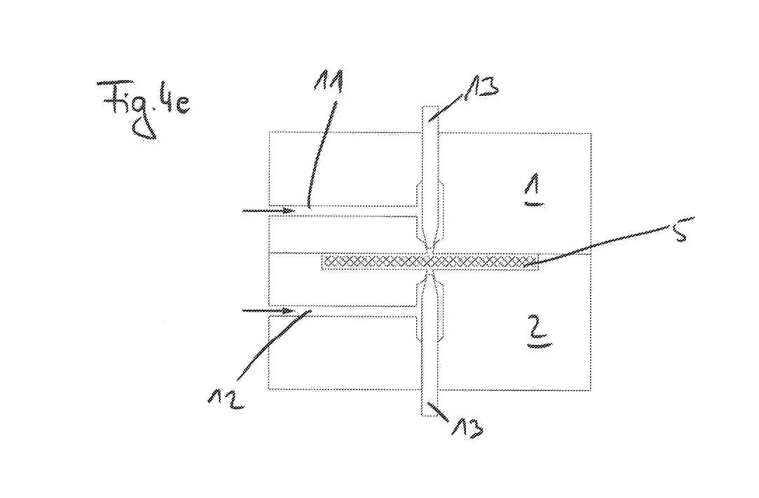

FIGS. 5-8 show several embodiments of the molding tool for the second variant of the invention.

FIG. 1 shows an exemplary molding machine for the production of a fiber-reinforces plastic part with a molding tool with a first mold half 1 and a second mold half 2. The molding tool is mounted on two mold mounting plates 6, 7 which are movable relative to each other. An insert part in the form of a preform (semi-finished fiber product 5) is already placed in the opened molding tool. For A control 8 is provided for controlling the molding machine; only two control lines are shown exemplarily. Lines, which transfer information to the control 8, are not shown.

The activating component A and the catalyzing component B are provided by a metering aggregate by means of two plunger injection units 9, 10. Alternatively, this can be carried out by means of a high pressure or low pressure metering device (not shown). By means of supply conduits 11, 12 (for example the supply conduits 11, 12 are formed as material-feeding hoses beyond the molding tool and as channels in the molding tool) the components A, B are supplied to the injection nozzles (not shown) and further into the mixing chamber for the purpose of mixing.

FIG. 2 shows that part of the cavity (sprue section 4) which acts as mixing chamber in the first variant of the invention and in which the components A, B are brought together.

FIG. 3a, 3b show the use of nozzles with shut-off needles 13 which are controlled by the control 8. The movement direction of the shut-off needles 13 is illustrated by arrows. FIG. 3a shows the position of the shut-off needles 13 in the closed position. Here, the shut-off needles 13 directly seal at the sprue section 4 so that there is no fluid-conducting connection between the nozzle side and the sprue section 4. FIG. 3b shows the position of the shut-off needles 13 during the injection. Here, the shut-off needles 13 are moved at least thus far rearward so that a discharge opening is exposed, through which the respective component A, B can flow into the sprue section 4.

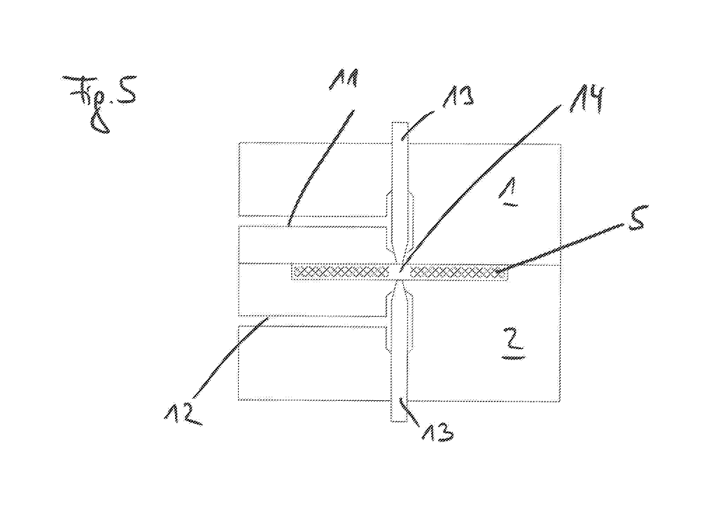

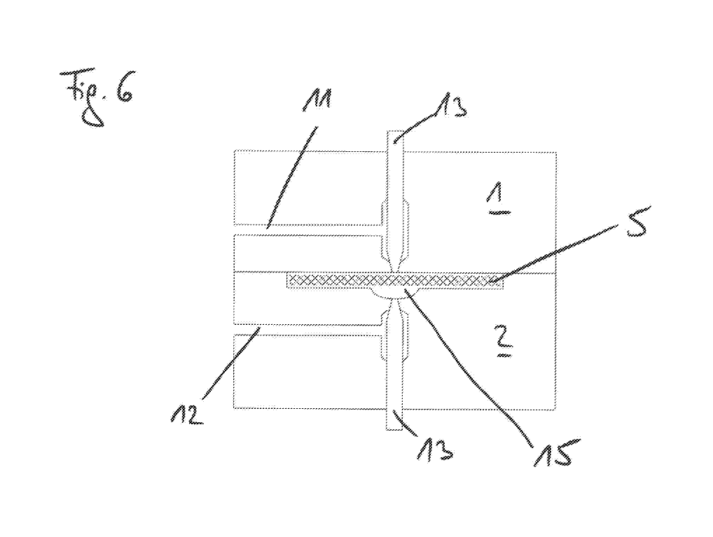

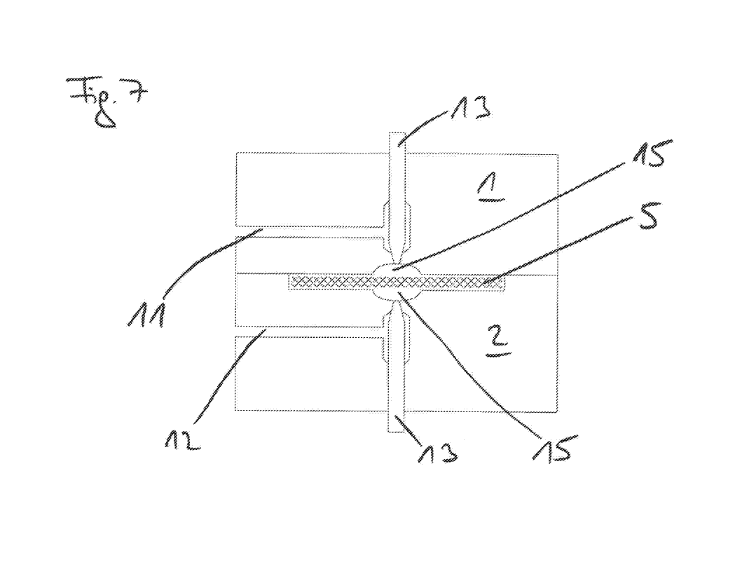

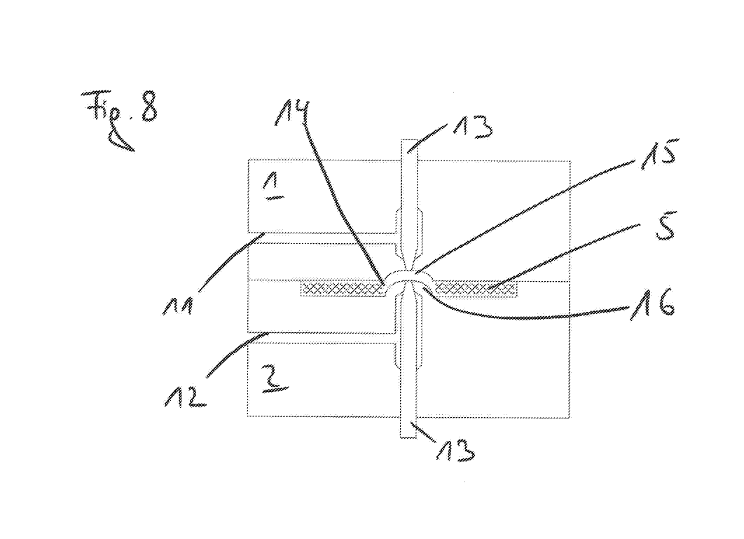

The FIGS. 4 to 8 are related to the second variant of the invention in the case of which the mold part section 3 acts as mixing chamber. Here, a semi-finished fiber product 5 with a through opening 14 located the mixing section can be used (alternatively, the semi-finished fiber product 5 could be thinned out in the mixing section). A one-sided or two-sided mixing calotte 15 can be formed in the mixing section (compare FIGS. 6 to 7). A convex wall area 16 can be provided alternatively or additionally (compare FIG. 8). Finally, the mixing section can be smooth on the outer side as well as on the inner side. This means, no additional geometric adaptations are made in the mixing section.

FIG. 4a shows the molding tool in the opened position. The shut-off needles 13 close the supply conduits 11, 12.

FIG. 4b shows the molding tool in the position of FIG. 4a, wherein a semi-finished fiber product 5 for the production of a fiber-reinforced plastic part is placed in the molding tool.

FIG. 4c shows the molding tool in the closed state. The shut-off needles 13 close the supply conduits 11, 12.

FIG. 4d shows the molding tool in the closed state. The shut-off needles 13 have been moved thus far away from the cavity-facing openings of the supply conduits 11, 12 so that the components A, B can be injected (FIG. 4e).

### LIST OF REFERENCE SIGNS

1 first mold half of the molding tool
2 second mold half of the molding tool
3 mold part section of the cavity
4 sprue section of the cavity
5 semi-finished fiber product
6 first mold mounting plate
7 second mold mounting plate
8 control
9 plunger injection unit for component A
10 plunger injection unit for component B
11 supply conduit for component A
12 supply conduit for component B
13 shut-off needle
14 through opening in the semi-finished fiber product
15 mixing calotte formed in the molding tool
16 convex wall area formed in the molding tool

1. A method for the production of plastic parts, in particular of composite parts, utilizing at least two components to be mixed in a mixing chamber and a cavity formed between a first and a second mold half of a molding tool, wherein the cavity comprises a mold part section and a sprue section, wherein the sprue section or the mold part section is used as mixing chamber.

2. The method according to claim 1, wherein a semi-finished fiber product is placed in the mold part section of the empty cavity, the semi-finished fiber product optionally having a through opening or being locally thinned out.

3. The method according to claim 1, wherein the sprue section is filled and the filling is fully polymerized to a sprue part and the sprue part is demolded together with the plastic part.

4. The method according to claim 1, wherein ε-caprolactam components are used.

5. A molding tool for the use in a method according to claim 1, wherein the molding tool comprises a cavity with a mold part section and a sprue section and a mixing chamber for mixing at least two components (A, B to be mixed, wherein the mixing chamber is formed by the sprue section or by the mold part section of the cavity.

6. The molding tool according to claim 5, wherein the molding tool comprises supply conduits for the at least two components, which supply conduits can each be closed by a shut-off needle.

7. The molding tool according to claim 6, wherein each shut-off needle seals the supply conduit directly at the sprue section.

8. The molding tool according to claim 1, wherein the molding tool comprises supply conduits for the at least two components, which supply conduits are arranged together with the sprue section in only one of the first mold half and second mold half of the molding tool.

9. The molding tool according to claim 1, wherein the molding tool comprises supply conduits for the at least two components, which supply conduits are thermally decoupled from the molding tool, preferably by isolations or casings, which particularly preferred are made of plastic of ceramic.

10. The molding tool according to claim 9, wherein separate tempering devices are provided for the supply conduits on the one hand and for the mixing chamber on the other hand.

11. The molding tool according to claim 1, wherein the sprue section is arranged rectangular to a parting plane of the first and second mold half of the molding tool.

12. The molding tool according to claim 1, wherein a closable cleaning or flushing conduit or a switchable drain bore is connected with the sprue section.

13. The molding tool according to claim 1, wherein an ejector and/or a vacuum module are/is provided for the sprue section.

14. The molding tool according to claim 1, wherein the molding tool comprises a mixing calotte being formed in one mold half or in both mold halves and adjacent to the part of the mold part section forming the mixing chamber and/or a convex wall area projecting into the mold part section.

15. A molding machine comprising a molding according to claim 1.
